(19) United States
(12) Patent Application Publication
(10) Pub. No.: US 2010/0180232 A1
(43) Pub. Date: Jul. 15, 2010

(54) Method and System for Grouping Buyers Based on Common Interests

(76) Inventors: David John Honan, Littleton, CO (US); Kenneth Joseph Hynes, II, Crosswicks, NJ (US); Brian Spencer Campbell, Centennial, CO (US)

Correspondence Address: David Honan, 10377 S. Lions Path, Littleton, CO, 80124, US

(21) Appl. No.: 12/687,097

(22) Filed: Jan. 13, 2010

Related U.S. Application Data
(60) Provisional application No. 61/144,282, filed on Jan. 13, 2009.

(51) Int. Cl. G06F 3/048

(52) U.S. Cl. 715/811

(57) ABSTRACT

Described herein are embodiments for identifying and grouping users of a system based on common interests and/or purchasing goals. In embodiments, one or more items of interest of a user are determined based on user input. A group is formed based on the on the one or more items of interest to the first user. At least a second user is identified based in part on at least one predetermined criterion and based in part on the second user having at least one or more items of interest corresponding to the one or more items of interest of the first user and the one or more items upon which the group was formed. Once the group is formed, the second user is automatically notified of the formation of the group. A third user is identified based on at least a second one of a predetermined criterion and the third user is given access to the group.

### CROSS-REFERENCE TO RELATED APPLICATIONS

This application claims benefit of priority to U.S. Provisional Patent Application No. 61/144,282, entitled “Method and System for Grouping Buyers Based on Common Interests”, filed on Jan. 13, 2009. The aforementioned priority application is hereby incorporated by reference in its entirety.

### TECHNICAL FIELD

The present disclosure generally relates to identifying and grouping users based on common purchasing goals.

### BACKGROUND

When purchasing an item, an individual typically drives to a mall or store of interest, selects one or more items for purchase, and has a cashier ring up the total amount for the purchase. The individual may then visit additional stores and go through the same routine. For some individuals, making the trek to the desired stores and locations can be very time consuming. With the advent of the internet, new channels of commerce have become available. Various online stores offer products for sale and ship the item directly to the individual's door. As commerce continues to evolve, product and service providers may be continually looking for new channels with which to advertise and reach potential buyers. Buyers, on the other hand, may be looking for additional channels with which to reach retailers and service provides from which the buyers may purchase their items.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Described herein are embodiments for identifying and grouping users of a system based on common interests and/or purchasing goals. In embodiments, one or more items of interest of a user are determined based on user input. A group is formed based on one or more items of interest to the first user. At least a second user is identified based in part on at least one predetermined criterion and based in part on the second user having at least one or more items of interest corresponding to the one or more items of interest of the first user and the one or more items upon which the group was formed. Once the group is formed, the second user is automatically notified of the formation of the group. A third user is identified based on at least a second one of a predetermined criterion and the third user is given access to the group.

Still yet other embodiments provide a method for grouping users of a system based on common interests. In such embodiments, a group is formed based on interests of at least one user. Additional users for the group are also identified based on at least one criterion. At least one additional user is automatically provided access to the group and a transaction is fastigiated between the members of the group.

Embodiments also provide a system for creating groups of users having common purchasing goals. The system is configured to determine purchasing interests of at least a first user. The first user is notified of at least a second user, the second user having at least one purchasing interest in common with the first user. A third user is identified that provides the purchasing interest in common with the first user and the second user.

Embodiments may be implemented as a computer a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instruction for executing a computer process.

### BRIEF DESCRIPTION OF THE DRAWINGS

Embodiments of the present disclosure may be more readily described by reference to the accompanying drawings in which like numbers refer to like items and in which:

FIG. 1A is a diagram illustrating a system that may be used to group users based on common interests according to embodiments.

FIG. 1B is a block diagram illustrating components of a system that may be used to group users based on common interests according to embodiments.

FIG. 2 illustrates a method for a goods and services provider to solicit users of the system according to embodiments.

FIG. 3 illustrates a method for a user of the system to create or join a group of users who share a common interest according to embodiments.

FIG. 4 illustrates a computing environment for implementing embodiments described herein.

### DETAILED DESCRIPTION

Various embodiments are described more fully below with reference to the accompanying drawings, which form a part hereof, and which show specific embodiments for practicing the embodiments described herein. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects.

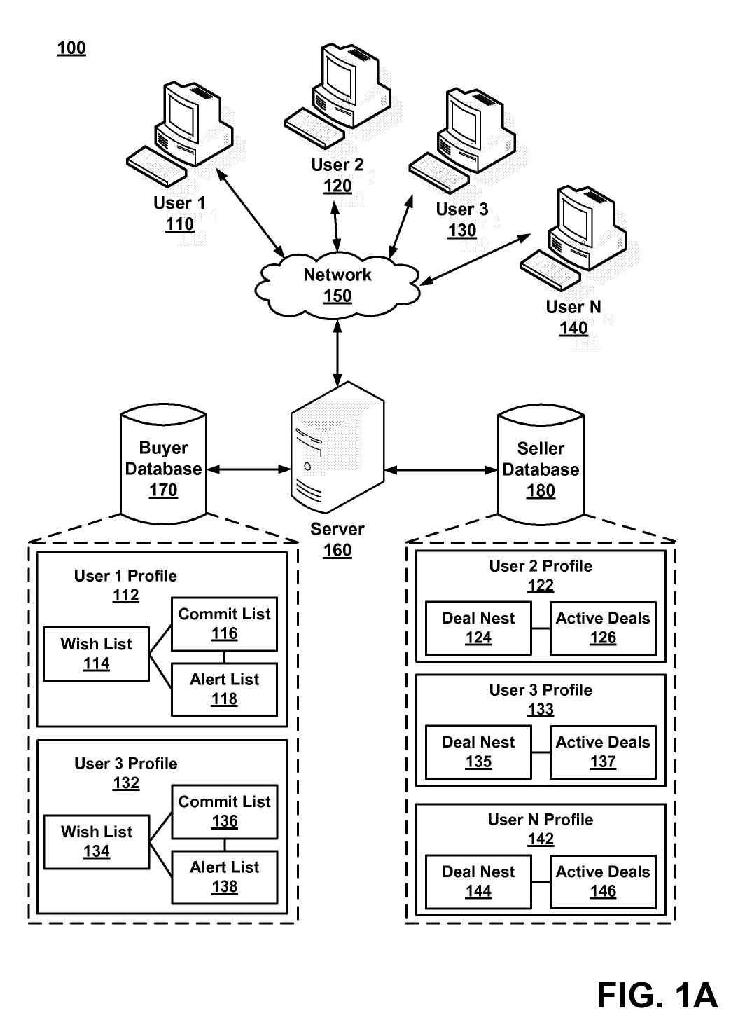

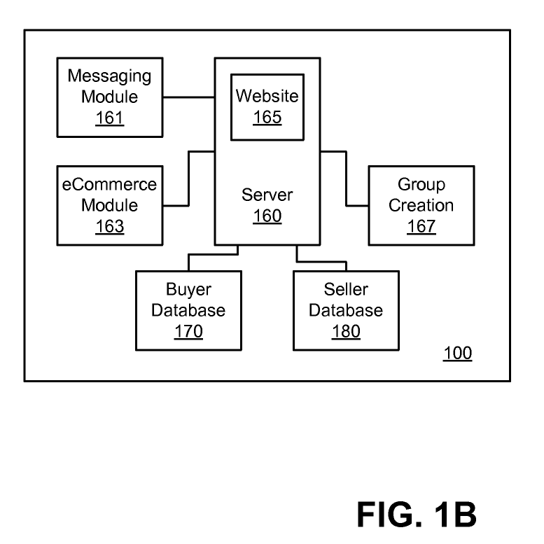

FIG. 1A is a diagram illustrating a system 100 that may be used to identify and group users of the system 100 based on common interests according to embodiments. The system 100 enables a plurality of users, such as for example, User 1 110, User 2 120, User 3 130 and User N 140, to be communicatively coupled to a server 160 via a network 150. The system 100 may also include a buyer database 170 and a seller database 180. Embodiments provide that the buyer database 170 includes information, such as profile information, corresponding to users that access the system as buyers. The seller database 180 contains information, such as profile information, corresponding to users that access the system 100 as sellers. Although the buyer database 170 and the seller database 180 are shown as separate databases, it is contemplated that a single database may be used.

As shown in FIG. 1B, additional components may also be included in the system 100. For example, system 100 may include an electronic messaging module 161 configured to facilitate electronic communication between users of the system. According to embodiments, the electronic messaging module 161 may generate and distribute messages when certain events occur in the system. Such examples include, but are not limited by, 1) an individual is invited to and/or joins the system, 2) when a user joins a group, 3) when a user comments on a deal, 4) if minimum group requirements have not been met, 5) when a group member has committed to purchase the deal, 6) when the seller has modified one or more details associated with the group, 7) when a minimum number of members of a group have committed to purchase the deal, 8) when the deal has been canceled and/or the group disbanded, 9) when the group will expire, 10) when a new deal has been active and/or a new group created, 11) when a user buys an item, or any combination thereof.

The system 100 may also include security layers and protocols (not shown), an ecommerce module 163 configured to facilitate secure transactions between users, and a group creation module 167 configured to assist in group creation and bid placement. Furthermore, although four different users are shown in FIG. 1, it is contemplated that any number of users may access the system, either separately or simultaneously.

Referring back to FIG. 1, system 100 may also include a feedback mechanism. According to embodiments, the feedback mechanism may provide users of the system means whereby they can rate other users of the system. The feedback mechanism may provide information for users as to whether they want to participate in a group and/or transaction with other users. For example a buyer may rate a seller based on a transaction, quality of the deal and/or the product or service. Furthermore a seller may rate a buyer based on whether the buyer followed through with a purchase.

As shown in FIG. 1, a user, such as User 1 110, may use a computing device to connect to the network 150 and access a webpage hosted on the server 160. According to embodiments, the computing device may be a personal computer, PDA, telephony device, or any other electronic device capable of connecting to a network. As one of skill in the art will recognize that there are a variety of communication methods that may encompass a network 150, including but not limited to the internet, analog telecommunications network, private data networks, and wireless type networks. Common to all of these networks is the ability of facilitate the transmission of data and information between one or more network components.

According to embodiments, the website 165 (FIG. 1B) hosted by the sever 160 is a site configured to enable various users, acting as buyers, to specify an item or service the user is looking to purchase. Thus, when a buyer indicates that they are actively looking for a particular product or service, the system either 1) generates a group and looks for additional users to add to the group who are searching for similar products or services, or 2) identifies one or more groups that have already been created by others users searching for similar products or services. The system 100 may also identify and notify users, acting as sellers, that one or more buyers are actively searching for a product or service offered by the seller.

For example, User 1 110 may access the system 100 as a buyer. When first requesting access, User 1 110 may be prompted to create a user profile, such as User 1 profile 112. Embodiments provide that User 1 profile 112 includes information about User 1 110 including by not limited to a name, contact information, and geographic location. Other information may be requested to facilitate a transaction between users of the system. The user may also create a wish list 114 that contains items and/or services the User 1 110 wants to purchase and/or receive in the future. A commit list 116 may also be generated to identifying items and/or services User 1 110 has committed to purchase. Additionally, User 1 profile 112 may include an alert list 118 which indicates items or services User 1 110 is actively looking to purchase. This information is editable, updated and be stored in a buyer database 170. example, User 1 110 may be prompted to enter in an email address, phone number, address as well as preferred means for communication.

The system 100 is also configured to enable sellers to list any number of items and/or services the user is offering including any, special deals, discounts, promotions, and the like. Thus, when a seller indicates that they are actively searching for buyers for a particular product or service, the system 100 may search the buyer database 170 for users and/or groups that are actively seeking the item or service provided by the seller.

In embodiments, sellers may be required to create a seller profile. The seller profile allows buyers to get information regarding the seller. Sellers may also use their seller profile to profile their businesses through the use of a profile definition wizard and/or display templates. The wizard is configured to guide the seller through the process of setting up a profile and optimizing the profile based on the seller's specific product or service and their competitive advantage. Embodiments provide for at least three levels of seller profiles: basic, advanced, and enterprise.

The basic template may give the seller a minimum level of information and tools to interact with the system, place bids, and transact with the buyer groups. In embodiments, this level does not provide for access to preset deals (described below) and only allows for sellers to participate in common interest deals (described below).

The advanced template includes the capabilities of the basic template and also provides for additional levels of visibility including user testimonials, shortened URLs, basic catalogs and photographs of work performed. It also provides for the ability to create preset deals. Targeted advertising, as will be explained below, can be purchased at this level.

The enterprise level includes the capabilities of the advanced and basic levels, and the ability to associate individual sales representatives to business cards, linking of locations, and advanced storefronts. Such a level may be used by national chains to enable the chains to work deals through individual sales representatives. In addition, geographic coverage, as will be explained in detail below, can be combined across each location, thereby allowing an entire grid or multiple geographic locations to be purchased at a corporate level and shared across each of the enterprises locations.

Continuing with the example, User 2 120 may access the system 100 as a seller. When first requesting access, User 2 120 may be prompted create a seller profile, such as for example User 2 profile 122. User 2 profile 122 may include information corresponding to User 2 120 including, but not limited to a name, contact information, and a geographic location. User 2 120 may also be prompted to indicate the type of seller profile (e.g., basic, advanced, or enterprise) User 2 120 will be using. User 2 profile 122 also includes an active deals 126 list containing deals that User 2 120 has activated and/or is currently involved in. User 2 profile 122 also includes a deal nest 124 containing deals the user wants to activate but are not currently active. This information is editable and may be stored in the seller database 180. Although specific types of information are mentioned, it is contemplated that other types of information may be collected from sellers to facilitate interaction between various users of the system 100.

Embodiments provide that a user may access the system as both a buyer and a seller. In such embodiments, a user may be prompted to create both a buyer profile and a seller profile. For example, User 3 130 may access the system 100 as a buyer looking for a specific item (e.g., 50″ plasma TV) and may also access the system 100 as a seller offering a service (e.g., pouring concrete). Therefore, User 3 130 creates a User 3 profile 132 that includes profile information for buyers as was discussed above, as well as a wish list 134, commit list 136 and an alert list 138. Additionally, User 3 130 also creates User 3 profile 133 that includes profile information discussed above with respect to sellers and also includes a deal nest 135 and list of active deals 137. Although a specific number of users have been discussed, it is contemplated that any number of users may access the system 100 and create profiles as buyers and/or sellers.

The system 100 enables a number of different deals to be currently active. Additionally, each buyer and seller may be involved in multiple deals. It is also contemplated that a buyer may be involved in one or more deals as a buyer and one or more deals as a seller. Likewise, a seller may be involved in one or more deals as a seller as well as one or more deals as a buyer.

According to embodiments, the system 100 provides information on different types of deals that may be available to the users of the system 100. One type of deal is a common interest deal. A common interest deal is a deal where a group is formed based on the system 100 determining, based on user input, that a user is actively seeking to purchase a particular item or service. This determination may be made based on the user moving a particular item or service from the user's wish list to an alert list. Alternatively, the buyer input the item or service directly onto the alert list. Embodiments provide that a user can also search for and join groups that already exist, even if the item or service for which the group was formed is not currently on the user's wish list or alert list.

Continuing with the above example, User 1 110 has a number of items on his wish list 114 (e.g., a Blu-ray DVD player, a 54″ LCD television, and wants a new concrete patio laid). User 1 110 determines the he is ready to purchase one of the items on his wish list 114 (e.g., the 54″ LCD television). User 1 110 moves this item from the wish list 114 to the alert list 118. Alternatively, User 1 110 may input the desired item or service directly to the alert list 118 list.

As will be explained in more detail below, when a user is actively looking for a product or service, the system 100 creates a group for the sole purpose of looking for additional buyers and sellers who are looking to buy and sell the particular product or service. As additional users are identified, the system notifies the users of the newly formed group. Alternatively, the user may join a preexisting group that was formed based on the product or service of interest.

In instances where the group is a newly created group, the system 100 searches for users that are looking for similar items. For example, User 3 130 may have a 50″ plasma television on his alert list 118. Although User 1 110 and User 3 130 are not looking for exactly the same item, the system may determine, based on the success of previous deals and/or user defined parameters, that both User 1 110 and User 3 130 satisfy the group requirements (e.g., television falling within a 46″ to 60″ inch range). As such, the system 100 may notify User 3 130 of the creation of the group.

When additional users join the group, communication may be established between each of the users in the group. Such communication may be public and available to all users of the system. Alternatively, the communication may be available only to all members of the group or even select members of the group. Other embodiments provide that one seller may not view deal details of a second seller for the same item. Still yet other embodiments provide that communication between group members may be facilitated on social networking sites, message boards, blogs and the like.

In addition to automatically notifying users of the group's formation, members of the group may personally notify and/or invite other users to the group. Still other embodiments provide that information regarding the group's creation (e.g., type of product or service requested) may be posted on a social networking sites, blogs, community message boards, etc.

When a predetermined set of group conditions have been met (e.g., number of buyers) the system 100 actively identifies users who are offering the product or service for which the group was created. The system 100 is configured to notify various users of the group's formation and solicits bids from those users. As will be explained in greater detail below, the system 100 may provide sellers data corresponding to the item or service for which the group was formed. For example, if the group was formed for the purpose of purchasing televisions, the system 100 provides data corresponding to previous and past deals regarding similar items, the number of members of the group, similarities in geographic location, feedback of each of the members of the group, a feedback score of the entire group, etc.

For example, when User 1 110 and User 3 130 join a group that was created for the purpose of purchasing a television, the system may determine, based at least in part on User 2 profile 122, that User 2 120 works at an electronics store. Furthermore, the system 100 may determine that based on input received from User 2 120, User 2 120 is willing to make a deal on the item for which the group was created (e.g., 20% off each high definition television purchased by members of the group). Upon receiving this deal, User 1 110 and User 3 130 may discuss, via electronic or other forms of communication, the terms of the deal and decide to either accept or reject the deal. If the deal is rejected, offers from additional sellers, such as for example, User N 140, may be considered provided the additional seller satisfies predetermined group criteria. If the deal is accepted, the system 100 facilitates a transaction between the User 1 110, User 2 120 and User 3 130 as well as any additional members that may have joined the group.

Situations may arise in which not all members of the group will accept the deal. For example, five of the eight users in the group may accept the deal while the remaining three reject the deal. In such instances, the system enables the remaining three users to receive bids from additional sellers. The remaining three users may then each accept the same deal. Alternatively, one user may accept a deal from one additional seller while the remaining two users accept a deal from a second one of the additional sellers.

Embodiments provide that multiple deals may be given to the group by multiple sellers. In these instances, the group members may examine all deals received, communicate with each of the sellers and other group members through mediums provided in the system, and decide on a specific deal. Still yet other embodiments that groups may be separated and combined based on deals that are accepted or rejected. When a group is combined or split, some embodiments provide that the original parameters of the group, such as minimum size of the group, must be met. It is also contemplated that when a deal is accepted and completed, the system may charge a predetermined percentage (e.g., 2%-3%) of the profit made by the seller.

A second type of deal enabled by the system 100 is a preset deal. According to embodiments, a preset deal is a deal where a user, acting a seller, submits an open offer for a product or service without waiting for a buyer group to form corresponding to the offered product or service. There are at least two subtypes of a preset deal. The first type of preset deal is a deal in which the seller requires that a group be formed before the stated deal will be transacted. For example, a User 2 120 may create a deal that states if a group will purchase a minimum number (e.g., 7) of 40″-55″ plasma TV's, the entire a group will receive a 30% discount. Furthermore, the seller may determine that the deal only lasts a predetermined amount of time (e.g. two weeks).

User 2 120 activates the deal by moving the deal from the deal nest 124 to the active deals 126. Alternatively, the User 2 120 may input the details of the deal directly into the active deals 126 list. The system 100 then identifies potential buyers. According to embodiments, the system 100 may determine potential buyers by checking an alert list of various users' profiles. For example, the system may check alert list 118 of User 1 profile 112 and alert list 138 of User 3 profile 132. Other embodiments provide that the system checks a user's alert list as well as the user's commit list. Still yet other embodiments provide that a user's wish list, commit list, and alert list are all checked. When potential buyers are identified, the system 100 notifies each of the identified users of the new deal. The notification may be in the form of an electronic notification and/or an electronic message. Examples include but are not limited to an email, a text message, text notification, mobile phone application, push message, TTS phone call back, social networking site, a blog, an instant message and the like.

When notified of the deal, each of the identified users may opt to join the group and participate in the deal. Alternatively, the user may opt to not join the group. Furthermore, each user may forward details of the deal to other users. The details may be transmitted to users and nonusers of the system 100 via an electronic message. Additionally, the details of the deal may be posted on blog, social networking site and the like. Once the requirements of the deal have been met (e.g., 7 users commit to purchasing a television), the deal closes. The buyers may then finalize the deal with the seller. As stated above, the transaction may be facilitated by the system 100. Other embodiments provide that the buyers and seller meet and facilitate the transaction in person.

A second type of preset deal is a deal in which a user, acting as a seller, has a specific number of items for sale and can determine beforehand the cost of each item. The seller can then place the items out for immediate sale.

For example, User N 140 has a specific number (e.g. 10) of 40″-55″ plasma TV's for sale and is offering a 20% discount on the entire stock. User N 140 activates the deal by moving the deal from the deal nest 144 of User N profile 142 to the active deals 146 list. Alternatively, the User N 140 may input the details of the deal directly into the active deals 146 list.

The system 100 searches for, and notifies potential buyers of the details of the deal. According to embodiments, the system 100 may determine potential buyers by checking the alert list, commit list, and/or wish list of a various user's profiles. When potential buyers are identified, the system 100 notifies each of the identified users of the new deal. The notification may be an electronic message, a posting on a blog, a notification automatically generated and posted on a social networking site, and any combination thereof.

When notified, each of the potential buyers may review the deal and make a purchase. Unlike the first preset deal described above, potential buyers need not wait for the group to be formed before making a purchase.

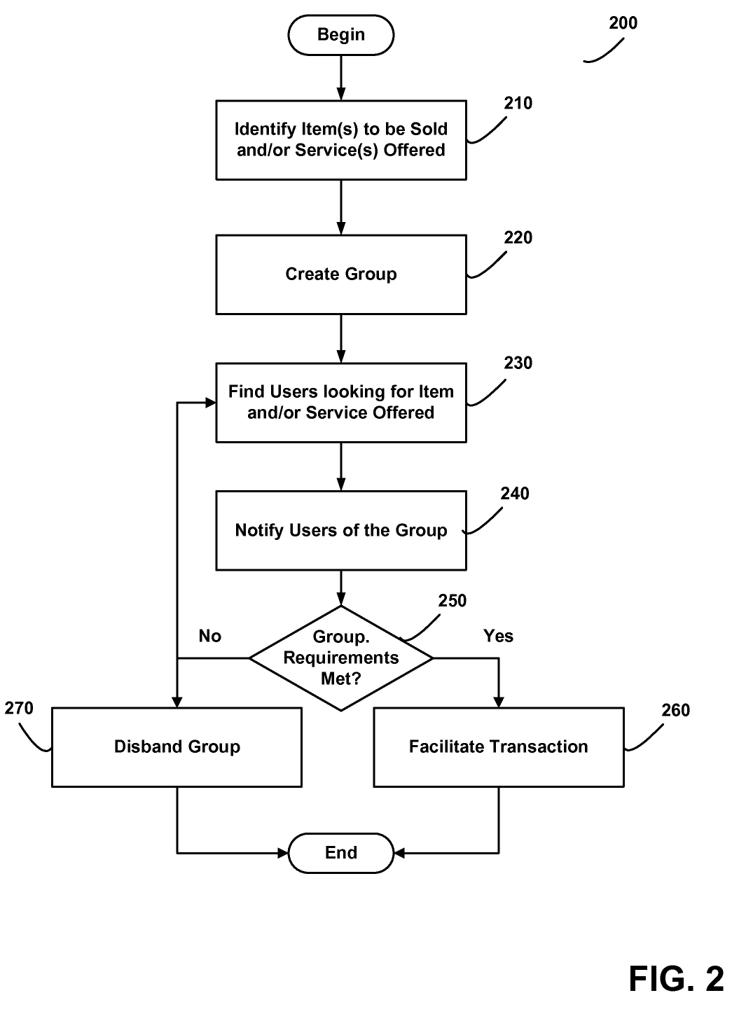

FIGS. 2-4 illustrate various aspects and features of a system, such as system 100 (FIGS. 1A-1B) for grouping users based on common interests according to embodiments. FIGS. 2-4 may also show or use components that were first described with respect to FIGS. 1A-1B. Therefore the description of FIGS. 2-4 may refer to at least one component described in FIGS. 1A-1B. However, any references to components of FIGS. 1A-1B are for descriptive purposes only.

FIG. 2 illustrates a method 200 for a goods and services provider to solicit users of a system according to embodiments. It is contemplated that prior to executing the method described with respect to FIG. 2, a user will have created a profile on the system as was described above with respect to FIGS. 1A-1B. When the method 200 begins, step 210 provides that a particular item or service offered by the seller is identified. Identification of the particular item or service occurs when a user, such as for example, User 2 122, moves a deal from a deal nest 124 to an active deal 126 list. It is also contemplated that the terms of the deal may be input directly into an active deal list.

According to embodiments, as the user creates a deal, either for the deal nest or the active deal list, the user may wish to include certain deal parameters. These parameters may include a time frame for the deal, a minimum number of users required for the deal, a maximum number of users allowed for the deal, geographic range of the deal, etc.

For example, User 3 130 may create a deal in the deal nest 135 for pouring concrete. The deal parameters set by User 3 130 may indicate that at least 5 users must commit to the deal, a predetermined minimum amount of concrete must be purchased by each user, and all work must be done within a certain geographic region (e.g., on the same street). Furthermore, the parameters of the deal may indicate that the deal is available for two weeks. If all parameters of the deal are met, User 3 130 will give each member of the group a 25% discount. However, if all of the deal parameters aren't satisfied in that time frame, the deal expires.

According to embodiments, a seller may use a group creation wizard to create the group. The seller group creation wizard may assist the seller in determining the parameters associated with the group. Such parameters may include an item category (e.g. television), item brand (e.g. Panasonic), purchase timeframe (e.g. 1 week), quantity (e.g. 15 items), minimum group size (e.g. 6), total discount (e.g., 15%) etc.

Embodiments provide that a user may join a group but need not commit to buy upon entering the group. Therefore, if eight users are in the group it is possible that only 3 actually commit to buy within the set timeframe. If the minimum number of committed buyers was five, the deal would expire for not meeting the parameters of the deal. It is also contemplated that if a certain number of users have joined the group but have not yet committed to buy, the seller may extend the life of the deal.

Once all parameters have been defined, flow moves to step 220 and a group is created. The group may require at least a predetermined number of members. A group such as this was described above with respect to the first type of preset deal. It is contemplated that additional parameters, other than minimum group size, may be required for the group. Such examples include a time frame for completing the deal, a minimum number of group members that have committed to the deal, a specific starting price range for items, brand types, sizes, type of services performed to name a few. Alternatively, the group may be a virtual group as described above with the second type of preset deal.

In Step 230, the system identifies users who are looking for the item(s) and/or service(s) offered in the deal. Step 240 provides that the identified users are notified of the deal and/or the group. Notification may occur via an electronic message or posting on a social network or blog. According to embodiments, the system identifies users who have moved the particular item(s) and/or service(s) into the user's alert list, commit list, wish list, or a combination thereof.

Continuing with the above example, when a group corresponding to the deal provided by User 3 130 is created, the system searches for additional users to join the group. The system determines that User 1 110 is looking for concrete work for a new patio. As stated above, this determination may be made based on User 1 110 moving “concrete work” from the wish list 114 to the alert list 118. Once identified, the system notifies User 1 110 of the deal. The notification may be via an electronic message or electronic notification. Alternatively, an indicator may be displayed, for example, on User 1's 110 profile page. User 1 110 may then review the terms of the deal and either accept or reject the deal. Upon acceptance, User 1 110 joins the group. As explained above, User 1 110 may join the group but not yet commit to purchasing the deal. Embodiments provide that User 1 110 may invite and/or notify others of the group.

Flow then proceeds to step 250 in which it is determined if the minimum group requirements have been met. The group requirements may include a minimum number of members, a maximum number of members, a geographic region, item type, minimum number of committed buyers etc. If the group requirements are met, flow proceeds to step 260 in which a transaction is facilitated between the users.

If however, it is determined that the group requirements have not been met, flow may proceed back to step 230 in which additional users are identified. It is also contemplated that current group members are automatically notified that the required group parameters have not been met. Such notifications may be sent at predetermined intervals, such as, for example, one week before the end of the group time frame, 3 days before the end of the group time frame etc. If the group requirements have not been met and/or the time frame for the deal has expired, flow proceeds to step 270 the group is disbanded.

In embodiments where the group being formed is a virtual group, flow may proceed from step 250 directly to step 260 in which a transaction is facilitated between the seller and the buyer. Although the transaction is complete between the seller and a first buyer, additional buyers may be identified and notified up until the deal expires and/or the seller has no additional items to sell. At such time, the group is disbanded.

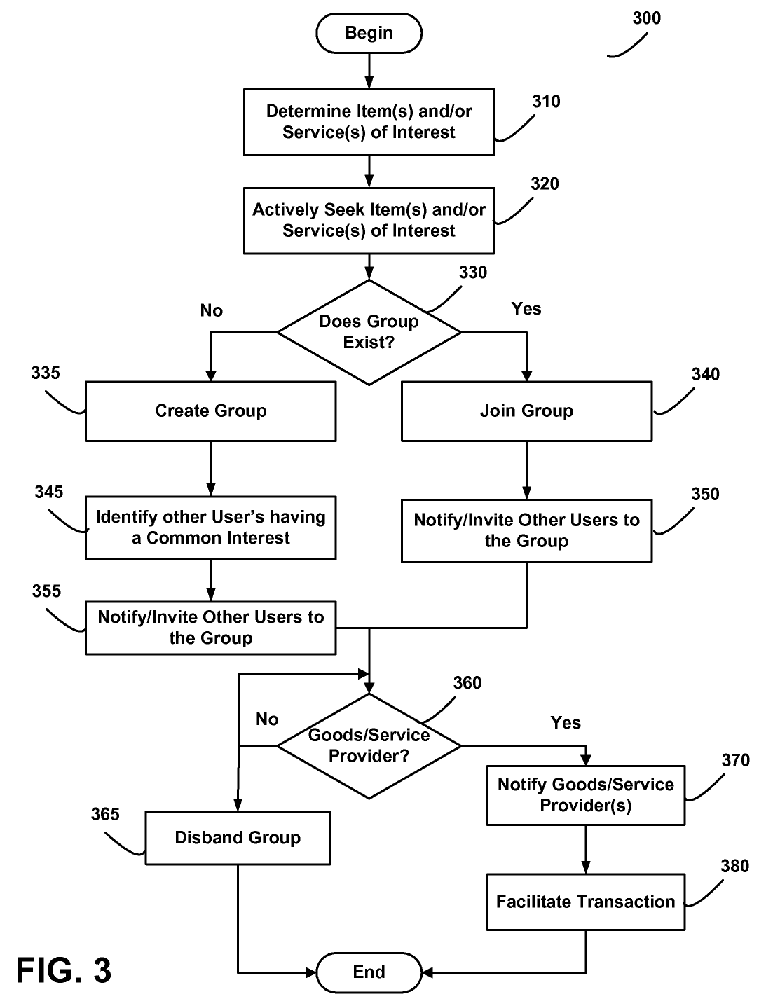

FIG. 3 illustrates a method 300 for a user to create or join a group of users who share a common interest according to embodiments. The method 300 described below may be used when creating a preset deal such as described above.

Step 310 of the method 300 provides that a user determines an item and/or service of interest. According to embodiments, this determination may include putting a desired item or service on a wish list. For example, User 3 130 may input details of an item (e.g. 50″ plasma television) onto the wish list 134 of User 3 profile 132.

Step 320 provides that a user actively seeks at least one item or at least one service of interest to the user. Embodiments provide that step 320 is accomplished by moving an item from a wish list to either an alert list, such as alert list 138, a commit list, such as commit list 136, or a combination thereof.

Once it is determined that a user is actively looking for a particular item or service, flow proceeds to step 330 in which it is determined if a group, corresponding to the item or service for which the user is actively seeking, exists. According to embodiments, items and services of interest may be divided into categories and subcategories. Thus, televisions may be included in an “electronics category”. Furthermore, the electronics category may have various subcategories, such as for example, and LCD category, a plasma category, projection category. Each of the sub categories may be further divided into additional subcategories such as 30″-35″ televisions, 36″-45″ televisions etc. Items can also be identified using an exact SKU (e.g. AVP-A1HDCI(A): Ultra-Reference 12 Channel A/V Home Theater/Multimedia Preamplifier with Network Streaming and Wi-Fi) or a product number.

If a group exists, flow proceeds to step 340 and the user may join the group. Embodiments provide that prior to joining the group, a determination may be made as to whether the user requesting access to the group meets predetermined criteria for group membership. One such criterion may be that the user is within a defined geographic region as will be described in more detail below. Other embodiments provide that only users who meet the predetermined criteria will be notified of the group's existence.

In step 340 the user joins the group. As a group member, the user may communicate with other members of the group. Additionally, members of the group may notify and invite others to the group as shown in step 350.

If it is determined in step 330 that a group corresponding to the item of interest does not exist, step 335 provides that a group is created. The group may be created by a group creation wizard. According to embodiments the group creation wizard determines the parameters associated with the group. Such parameters may include an item category (e.g. television), item brand (e.g. Panasonic), purchase timeframe (e.g. 1 week), preferred Store/Seller (e.g. “Ultimate Electronics/Luke), quantity (e.g. 1 item), group size (e.g. 6), etc. Embodiments also provide that the group creation wizard requests assistance from a guide. The guide is a user of the system that takes a percentage of the transaction for guiding a group to the best deal and/or seller. Embodiments provide the guide may be selected based on a rating system, feedback system, reputation or a combination thereof.

The new group wizard may also step the Buyer through the process of creating and leading the new buying group. The new group wizard may also provide data based on previous deals. Such data correspond to: 1) an optimum radius setting to set a boundary for the group; 2) determining a level to set the product or service category for the group (e.g. LCD Flat Screen or LCD Flat Screen→Sony Bravia→Model 52″ BRAVIA® XBR® LCD Flat Panel HDTV); 3) a minimum and/or maximum number of group members based on the type of product or service; 4) assisting users with creating the communication mechanisms between the seller and members of the group; 5) assisting with the deal request process based on elements from past deals such as the number of items, the final deal value, timing of grouping process, and the number buyers in the group; and 6) setting the allowed individual ratings associated with the buyers in the group and/or the overall rating of the group. The wizard may also include a buyer dashboard configured to determine the likely bid response from sellers who will potentially receive bid solicitations from the group.

When the group has been created, flow passes to step 345 and additional users having a common purchasing interest are identified. According to embodiments, the additional users are identified if certain group parameters are satisfied. For example, group parameters may include users within a predetermined geographic region and/or having an item on an alert list that is similar, or substantially similar, to the item for which the group was created.

In step 355, identified users are notified and/or invited to the join the group. Notification may be facilitated by the system. Additionally, the identified users may be notified by an electronic message and/or electronic notification.

Step 360 provides that a determination is made as to whether a goods or services provider exists within the group parameters. For example, the system will search for users, acting as sellers, within a predetermined geographic region. As will be explained in more detail below, sellers may have access to a particular geographic region by buying a subscription to one or more regions.

If it is determined in step 360 that a seller is not available, step 360 may be repeated. According to embodiments, step 360 may be repeated until either a seller is found, or until the time frame for the group has elapsed. If the time frame associated with the deal has elapsed, or a seller can't be found, flow proceeds to step 365 and the group is disbanded.

Other embodiments provide that if a seller is not found within the predetermined geographic boundaries, neighboring geographic boundaries may be searched for sellers. If sellers are found within the neighboring geographic boundaries, the sellers may be given an option to sell to the group. Embodiments also provide that the seller may be required to pay a onetime fee to sell to users outside the geographic region the sellers are currently subscribes to. Other embodiments provide that the seller may have to first subscribe to the geographic area prior to selling to user's is the area. Still yet other embodiments provide that if a seller, or minimum number of sellers, are not found within the geographic region, the system accesses a database or other storage mechanism that contains information for product and/or service providers in a given geographic region (e.g., county, state, country etc). The system may then determine which of the product and/or service providers provide the product or service requested by the group. The system may then contact the identified product and/or service provider in an automated or manual manner.

If a determination is made in step 360 that a seller is found that matches the group's criteria (e.g., subscribes to the predetermined geographic area and offers the item or service), step 370 provides that the identified seller is notified of the formation of the group. The notification may be an electronic message or other electronic notification. It is contemplated that a number of different sellers may have access to a single geographic region. Therefore, it is possible that the group may receive offers from a number of different sellers.

Embodiments provide that a bid wizard may be included assist a seller in responding to the bid as well as providing data to the seller to enable the seller to be competitive with the other sellers who are likely to respond to the bid solicitation from the group. The data included in the bid wizard may be data corresponding to: 1) previous and past deal elements such as the number of items, the final deal value, timing of grouping process, the number buyers in the group, etc.; 2) buyer/group preferences, such as whether the group is looking for a very specific model or is open to other suggestions or options; 3) the individual ratings associated with the buyers in the group and/or the overall rating of the group; 4) the proximity of the buyers to each other and to the seller as well as the proximity of the additional sellers who received the bid solicitation from the group; and 5) calculators to assist the seller with determining final cost/profit to help them be as competitive as possible with their bid. The bid wizard may also include a seller dashboard configured to determine the likely bid response from the other sellers who received the bid solicitation based on the above elements.

When a bid has been accepted by the group, flow passes to step 380 and a transaction is facilitated between the selected seller and the members of the group. Embodiments provide that the system may facilitate a portion of, or the entire transaction via an ecommerce mechanism. Alternatively, transaction can be facilitated externally from the system through the user of a deal contract and/or deal number.

### Geographic Regions

In an embodiment, a grid may be used to facilitate and aid in both the segmentation of geography (e.g. United States, Canada, Mexico) into Seller coverage segments and the selection of Buyers that are eligible for a deal. Alternative embodiments provide that geographic regions are divided by zip code, area code, city boundaries, or county boundaries.

In embodiments where grids are used to set a geographical area within which a Seller can conduct business, grid squares are determined and are contained by a set of at least four geographical points. Alternatively, the grid squares can be shaped as needed to fit the contours of the geography.

Embodiments provide that a seller can subscribe to a section of a grid or multiple sections of the grid. In embodiments where a zip code, area code and the like are used, the seller may subscribed to one or more geographic areas defined in such a manner.

Geographic areas determine which groups the seller may send bids to. For example, the seller will only be allowed to send bids to groups whose entire membership fall (or, only those Buyers in the group that are) within the grids the seller subscribed to. In instances where a virtual group is created as described above, the seller may only accept buyers that are within the seller's subscribed geographic boundaries.

In yet other embodiments, the system provides for a concentric circle based geographical subscription model. The concentric circles may be centered on the originator of the group (i.e. using Latitude and Longitude point of the originator's address or postal code) with each circle section segmented into slices (not necessarily equal sized). The distance between each of the outer rings of the concentric circles will be determined by the geographic needs of the area covered. In this case, the Sellers would purchase slices as needed in a similar manner to the grid sections or geographic regions described above.

In instances where a buyer is the originator of the group, such as for example, with a common interest deal, the center point of the group may be set to the location of the group's originator. The overall coverage area of the group is determined by the settings selected by originator of the group (assisted by the system). Whether a Buyer can join a group is determined by the attributes associated with the group—including radius. The system will provide a recommendation for the geographical coverage (e.g. radius or postal code) to the group's originator based on historical transactions and/or other factors (e.g. average radius of current active Preset Deals).

When a seller is the originator of the group, such as for example the two types of preset deal described above, the overall coverage area of the group of candidate buyers may be determined by the grid coverage or the geographic area that the seller has subscribed to. Additionally, coverage may be determined by the settings selected by the seller, and assisted by the system through use of one of the wizards, at the time of the creation of the deal.

Still yet other embodiments provide that sellers are allocated deal or referral points. In such instances, sellers are given a predetermined number of free points (e.g., 5). Sellers may purchase additional points on a per deal basis, a referral basis, or simply purchase a block of points for a predetermined amount (e.g., 50 points for $30, 100 points for $50, unlimited points $150 per year etc.). Points are consumed when at least one of the following occurs: 1) a buyer starts a buying group (e.g., a common interest deal). Sellers that receive notification of the group will be charged at least one point. 2) A seller starts a group. In such instances, a point is consumed when the group is activated. According to embodiments, sellers can purchase additional points or upgrade to a yearly subscription at any time.

### Grouping Algorithm

According to embodiments, the grouping process may consider various criteria including: product or service of interest, buying timeframe, maximum number of group members, distance between buyers and sellers, and the proximity between the group of buyers and the potential sellers. The system may utilize proximity searching using geocoding.

For geographies where geocoding and geospatial information is not available, an alternate mechanism may be used. This can be a combination of MSA (metropolitan statistical areas), City boundaries, postal code points, street density, Distance & Bearing, etc. The grouping mechanism will differ based on what type of geospatial information is available. Other groups may be made based on city or postal code coverage. The processes for grouping for countries where geospatial information is not available may be similar to the process described above.

Geographical points used to determine distance can be any predictable spatial types such as for example, latitude/longitude points, postal codes, city names, streets, GPS position, etc. Additionally, the system may consider the area of coverage of the geographical grids and the number and placement of the grids that a particular seller subscribes to. The proximity between the groups of buyers may be optional and set by the group originator and/or with assistance from the system.

The proximity element between the individual buyers within a group may provide a more level playing field between large volume, national sellers and the local, smaller sellers. This may be done when it is determined that a seller can service buyers who do not have access to large cities or are in remote locations. However, if it is determined that a seller cannot offer the product or service to the remote individual, the buyer can create a group and solicit bids from sellers that have subscribed to sell products and services within the buyer's grid.

### Targeted Advertising

In embodiments, the system allows for the purchase of advertising space on the web pages (or other user interfaces) associated with the system. The advertising associated with this system is targeted based on multiple elements including: 1) the proximity/geographical area associated with an individual buyer or the individual buyers within a group; 2) the contents and categories associated with the products or services on an individual buyer's alert list, wish list commit list or a combination thereof; and 3) advertising based on other factors such as elements of the alert list of friends, contacts, groups etc. as well as buying history of the user, product lifecycle upgrades, and popular products and services in the buyer's geographical area.

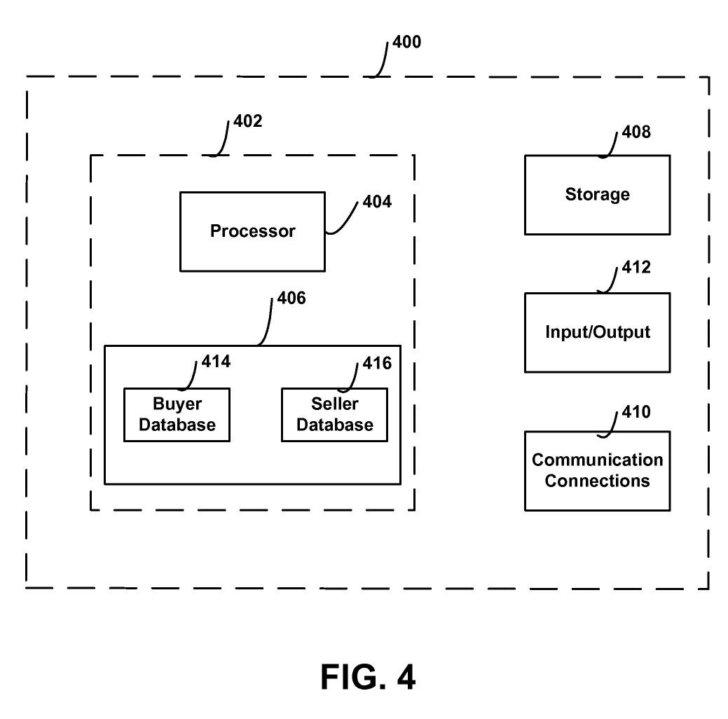

With reference to FIG. 4, an embodiment of a computing environment for implementing the various embodiments described herein includes a computer system, such as computer system 400. Any and all components of the described embodiments may execute as or on a client computer system, a server computer system, a combination of client and server computer systems, a handheld device, and other possible computing environments or systems described herein. As such, a basic computer system applicable to all these environments is described hereinafter.

In its most basic configuration, computer system 400 comprises at least one processing unit or processor 404 and system memory 406. The most basic configuration of the computer system 400 is illustrated in FIG. 4 by dashed line 402. In some embodiments, one or more components of the described system are loaded into system memory 406 and executed by the processing unit 404 from system memory 406. Depending on the exact configuration and type of computer system 400, system memory 406 may be volatile (such as RAM), non-volatile (such as ROM, flash memory, etc.), or some combination of the two.

Additionally, computer system 400 may also have additional features/functionality. For example, computer system 400 includes additional storage media 408, such as removable and/or non-removable storage, including, but not limited to, magnetic or optical disks or tape. In some embodiments, software or executable code and any data used for the described system is permanently stored in storage media 408. Storage media 408 includes volatile and non-volatile, removable and non-removable media implemented in any method or technology for storage of information such as computer readable instructions, data structures, program modules, or other data.

System memory 406 and storage media 408 are examples of computer storage media. Computer storage media includes, but is not limited to, RAM, ROM, EEPROM, flash memory or other memory technology, CD-ROM, digital versatile disks (“DVD”) or other optical storage, magnetic cassettes, magnetic tape, magnetic disk storage, other magnetic storage devices, or any other medium which is used to store the desired information and which is accessed by computer system 400 and processor 404. Any such computer storage media may be part of computer system 400. In embodiments, system memory 406 and/or storage media 408 stores data used to perform the methods or form the system(s) disclosed herein. In embodiments, system memory 406 stores information such as buyer profiles 414 and seller profiles 416.

Computer system 400 may also contain communications connection(s) 410 that allow the device to communicate with other devices. In embodiments, communications connection(s) 410 may be used to transmit and receive messages between sender devices, intermediary devices, and recipient devices. Communication connection(s) 410 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media. In an embodiment, the methods described above may be transmitted over the communication connection(s) 410.

In some embodiments, computer system 400 also includes input and output connections 412, and interfaces and peripheral devices, such as a graphical user interface. Input device(s) are also referred to as user interface selection devices and include, but are not limited to, a keyboard, a mouse, a pen, a voice input device, a touch input device, etc. Output device(s) are also referred to as displays and include, but are not limited to, cathode ray tube displays, plasma screen displays, liquid crystal screen displays, speakers, printers, etc. These devices, either individually or in combination, connected to input and output connections 412 are used to display the information as described herein. All these devices are well known in the art and need not be discussed at length here.

In some embodiments, the component described herein comprise such modules or instructions executable by computer system 400 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 400 is part of a network that stores data in remote storage media for use by the computer system 400.

### ALTERNATIVE EMBODIMENTS

Alternative embodiments provide that if a user is interested in a certain item or service, the user may also be interested in a related item or service that the same seller, or another seller, is offering. The user may be notified of any deals corresponding to the related item or service. For example if the user moves and HD television from a wish list to an alert list, the system notify the user that at least one seller in the user's geographic region has a Blu-ray DVD deal.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A method of assembling a group of users based on common interests, the method comprising:
determining, based on input from a first user, one or more items of interest to the first user;
forming the group, wherein the group is formed based on the one or more items of interest of the first user;
identifying, based on at least one predetermined criterion, at least a second user, wherein the second user has at least one or more items of interest corresponding to the one or more items of interest of the first user and the one or more items upon which the group was formed;
automatically notifying the at least a second user of the formation of the group;
identifying a third user, wherein the third user is identified based on at least a second one of a predetermined criterion; and
providing the third user access to the group.

2. The method of claim 1, wherein the at least one predetermined criterion is a geographic area.

3. The method of claim 1, wherein the input from a first user is a wish list.

4. The method of claim 1, further comprising adding additional users, wherein each of the additional users satisfies the at least one predetermined criterion and wherein each of the additional users has at least one or more items of interest in common with the one or more items of interest in common with first user and the second user.

5. The method of claim 4, wherein the additional users are added to the group until at least one predetermined condition of a set of predetermined conditions have been met, the set of predetermined conditions being selected from a group consisting of i) a minimum group size, ii) a maximum group size, iii) a time frame; and iv) a combination thereof

6. The method of claim 1, further comprising enabling communication between users in the group.

7. The method of claim 1, wherein the group is formed by the third user prior to adding the first user and the second user, and wherein the group formed by the third user is based at least on a service offered by the third user.

8. The method of claim 7, wherein the service offered by the third user corresponds to the at least one or more items of interest to the first user.

9. The method of claim 1, further comprising, facilitating transactions between users in the group.

10. The method of claim 1, wherein the at least a second one of a predetermined criterion is selected from a group consisting of i) a geographic region, ii) a service provided the third user, where in the service provided by the third user corresponds to the one or more items of interest of the group, iii) a price for the service provided by the third user, and iv) a combination thereof.

11. A computer storage medium encoding computer executable instructions that when executed by a processor perform a method for grouping users of a system based on a common interest, the method comprising:
forming a group based on an interest of a user;
identifying, based on at least one criterion, at least one additional user for the group;
automatically providing the at least one additional user access to the group; and
facilitating a transaction between users of the group.

12. The method of claim 11, wherein at least one user of the group provides a product or service on which the group was formed.

13. The method of claim 12, wherein the at least one user of the group that provides a product or service on which the group was formed bids for an opportunity to provide the product or service.

14. The method of claim 11, wherein the group is formed based on a set of predetermined criteria, the criteria being selected from a group consisting of i) a geographic region, ii) a minimum size of the group, iii) a maximum size of the group, iv) a time limit in which the group is active, and v) a combination thereof.

15. The method of claim 11, further comprising enabling communication between users of the group.

16. The method of claim 11, further comprising enabling users of the group to invite additional users to the group.

17. A system for creating groups of users having common purchasing goals, the system comprising:
a processor; and
a memory, the memory having computer executable instructions stored thereon, that when executed by the processor:
determines purchasing interests of a first user;
notifies the first user of at least a second user having at least one purchasing interest in common with the first user; and
identifies a third user, wherein the third user provides the purchasing interest in common with the first user and the second user.

18. The system of claim 17, further comprising receiving a set of instructions from a third user, the set of instructions indicating that the third user is offering a particular product or service.

19. The system of claim 17, further comprising forming a group having at least one of the first user, the second user, the third user, or a combination thereof.

20. The system of claim 17, wherein the second user is a member of a group, wherein the group is based on at least the one purchasing interest in common with the first user and the second user.
